(19) United States
(12) Patent Application Publication
(10) Pub. No.: US 2005/0252962 A1
(43) Pub. Date: Nov. 17, 2005

(54) Communication system

(75) Inventors: Gerd Dirscherl, Munich (DE); Till Winteler, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/119,426

(22) Filed: Apr. 28, 2005

(30) Foreign Application Priority Data
May 14, 2004 (DE) 10 2004 024 158.9

(51) Int. Cl. G06K 5/00; G06K 7/06

(52) U.S. Cl. 235/380; 235/441

(57) ABSTRACT

Communications system having a chip card and at least one chip card communications partner, the chip card having a module for initiating data interchange with the chip card communications partner, and a method for interchanging data between a chip card and a chip card communications partner, the chip card initiating data interchange.

### CROSS-REFERENCE TO RELATED APPLICATION

This application claims priority to German Patent Application Ser. No. 10 2004 024 158.9, filed May 14, 2004, and which is incorporated herein by reference in its entirety.

### FIELD OF THE INVENTION

The invention relates to a communications system having a chip card and at least one chip card communications partner.

### BACKGROUND OF THE INVENTION

FIG. 1 shows a communications system 1 which is known from the prior art and has a chip card 2 and a chip card communications partner 3, as specified, for example, in the “Handbuch der Chipkarten [Chip card handbook], W. Rankl, W. Effing, 3rd Edition, Carl Hanser Verlag, Munich, 1999”. The chip card 2 in such a communications system 1 comprises an integrated circuit, the so-called chip, which is connected to a card body. The chip card communications partner 3 is usually a terminal or a reader. The chip card 2 and the chip card communications partner 3 communicate via an interface 4 which may be a standard interface. The chip card communications partner 3 controls communication with the chip card 2 in accordance with the “challenge/response method”. In this case, the chip card communications partner 3 sends a command as a “challenge” to the chip card 2 which processes the command without delay, generates a reply and sends the latter back to the chip card communications partner 3 as a “response”. The chip card 2 always plays the passive role of a so-called “slave” in the communications system 1 since it has to wait for instructions from the “master”, the chip card communications partner 3.

This master/slave relationship is most pronounced in first-generation chip cards, memory cards. The latter are used, for example, in telephone cards or health insurance cards, the functionality being restricted to the storage and interchange of data. In order to keep the total costs of this communications system low, the memory cards (produced in large quantities) were designed as simply as possible, and the functionality required for communication was moved, as far as possible, to the few terminals. Further simplification was achieved by using a synchronous interface that prescribes the flow of communication in a relatively rigid manner, however.

The next generation of chip cards, the so-called microcontroller cards, also have a microcontroller and programmable software in addition to the memory. Chip cards of this type are, for example, bank cards having an encryption function or SIM (Subscriber Identity Module) modules in GSM mobile telephones. In order to interchange data, use is made of more flexible interfaces, as specified, for example, in the ISO-7816-3 standard. In spite of the greatly extended functionality of the chip cards, communication between a chip card and a terminal is still controlled by the terminal and is still based on the challenge/response method. If this was advantageous in the case of memory cards, it constitutes a restriction for microcontroller cards. If, for example, an error occurs in the chip card 2 and communication is disrupted as a result, the chip card 2 cannot itself inform the chip card communications partner 3 of the error. The chip card communications partner 3 will nevertheless attempt to continue to communicate by sending the data again. The chip card 2 can only inform the chip card communications partner 3 that the data have not been received correctly. However, it is not able to assume control of communication.

In the future, chip cards having an even greater range of functions, the so-called smart cards, will be manufactured and used. These will make it possible, for example, to control operations on a mobile phone using a smart card. To this end, however, the chip card must assume control of the communications system, i.e. must be able to assume the role of master. However, this is not provided for in today's communications systems 1; the chip card 2 can only react, as a slave, to commands from the chip card communications partner 3 and cannot itself start any actions. Without the possibility of initiating data interchange with a chip card communications partner 3, the possible field of use of chip cards 2 is greatly restricted.

### SUMMARY OF THE INVENTION

Therefore, the invention is based on an object of specifying a communications system having a chip card and at least one chip card communications partner, in which the chip card can initiate data interchange.

The object is achieved, according to the invention, by virtue of the fact that the chip card has a module for initiating data interchange with the chip card communications partner, and that a method for interchanging data between a chip card and a chip card communications partner is specified.

In accordance with one development of the invention, the chip card has a standard interface for communication. This has the advantage that existing terminal infrastructures can be used.

One preferred embodiment variant of the inventive communications system provides an additional line which does not belong to the standard interface and is intended to transmit an initiation signal to the chip card communications partner. This additional line makes it possible for the initiation signal to be transmitted to the chip card communications partner even when no such possibility is provided for in the standard interface.

The communications system advantageously has a standard interface in accordance with the ISO-7816 standard. This ensures compatibility with the existing reader infrastructure.

### BRIEF DESCRIPTION OF THE DRAWINGS

The invention will be explained, by way of example, in more detail below with reference to the figures, in which:

FIG. 1 shows a known communications system having a chip card and a chip card communications partner;

FIG. 2 shows a communications system having a chip card and a chip card communications partner, in which the initialization signal is transmitted via a standard interface; and

FIG. 3 shows a communications system having a chip card and a chip card communications partner, in which the initialization signal is transmitted via an additional line which does not belong to the standard interface.

### DETAILED DESCRIPTION OF PREFERRED EMBODIMENTS OF THE INVENTION

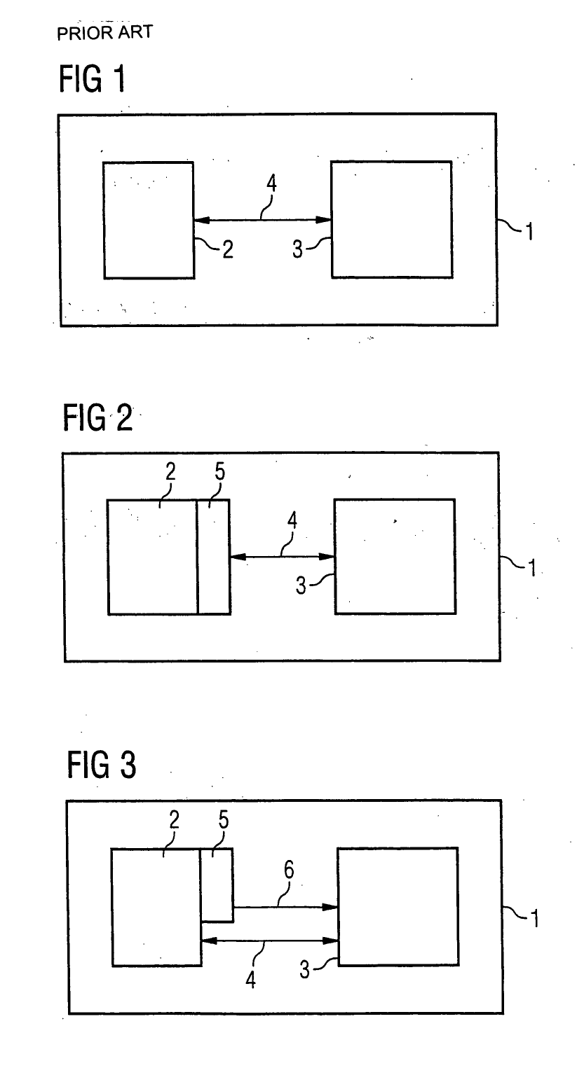

FIG. 2 shows one exemplary embodiment of the inventive communications system 1 having a chip card 2 and a chip card communications partner 3. In this case, in comparison with FIG. 1, the chip card 2 has been extended by a module for initiating data interchange 5 with the chip card communications partner 3. Data are still interchanged via an interface 4 which may also be in the form of a standard interface. The chip card 2 may also be connected to the communications partner 3 via a plurality of interfaces 4 which are not necessarily identical. It may also be connected to a plurality of communications partners 3 and simultaneously communicate with the latter. For reasons of clarity, the illustration of a plurality of communications partners and a plurality of interfaces has been omitted.

In this exemplary embodiment, signaling for the purpose of initiating data interchange is effected via the existing standard interface 4. The module for initiating data interchange 5 is used by the chip card 2 to signal to the chip card communications partner 3 that it would like to communicate with the latter. This may be effected, for example, by a data line in the standard interface, which, when no data are presently being interchanged, signals a high state by default, being changed by the module for initiating data interchange 5 in order to signal a low state. The communications partner 3 then recognizes that the chip card would like to start data interchange and prepares for the latter. In this exemplary embodiment, no extra line or extra interface is used to signal the initiation of data interchange but rather an existing line, for example a data line, is manipulated. If the standard interface used is an interface in accordance with the ISO 7816-3 standard, signaling may also be effected via at least one of the three unused contacts C4, C6 and C8.

FIG. 3 shows an exemplary embodiment in which, in comparison with FIG. 2, an additional line or interface 6 is used to transmit an initiation signal. This may be necessary, for example, if the data line in the standard interface 4 is not available for manipulation for the purpose of signaling. In this case, the chip card 2 is connected to the communications partner 3 via an extra line 6 and the module for initiating data interchange 5. Data are interchanged via the standard interface 4.

It is obvious that the invention is not restricted to the ISO 7816-3 interface. In principle, the invention functions with all other interfaces and protocols which are based on the master/slave system.

The fact that the chip card 2 is able to initiate data interchange results in a wealth of new options for use. It is thus conceivable, for example, for the chip card to independently use a mobile phone to make contact with a provider in order to request information and send information to the provider. The chip card 2 could thus inform the provider that it is, for example, a locked card or that an attempt was made to manipulate it. It is equally expedient if the chip card 2, without being requested to do so, can inform the chip card communications partner 3 that it has had a problem which is restricting its functionality or is even making its functionality impossible. A further conceivable use is signaling to the communications partner 3 if the communications system 1 is in a quiescent or standby state and the chip card 2 would now like to communicate that communication is to be continued.

In comparison with other solutions, the invention affords the advantage that the chip card 2 can signal to the chip card communications partner at any time that it would like to initiate data interchange.

The above description of the exemplary embodiments in accordance with the present invention serves only to illustrate and not to restrict the invention. Various changes and modifications are possible within the scope of the invention without departing from the scope of the invention and its equivalents.

1. A communications system comprising a chip card and a chip card communications partner, wherein the chip card has a module for initiating data interchange with the chip card communications partner.

2. The communications system of claim 1, wherein the chip card has a standard interface.

3. The communications system of claim 2, wherein the chip card has a plurality of standard interfaces.

4. The communications system of claim 1, further comprising a plurality of chip card communications partners, wherein the chip card module initiates data interchange with the plurality of chip card communications partners.

5. The communications system of claim 2, comprising an additional line, which is not part of the standard interface, and is for transmitting an initiation signal.

6. The communications system of claim 2, wherein the standard interface corresponds to the ISO-7816 standard.

7. A method for interchanging data between a chip card and a chip card communications partner, wherein the chip card initiates data interchange.

8. The method of claim 7, wherein the data interchange is initiated by signaling using a standard interface.

9. The method of claim 8, wherein the data interchange is initiated by signaling using a plurality of standard interfaces.

10. The method of claim 7, wherein the chip card initiates the data interchange with a plurality of chip card communications partners.

11. The method of claim 7, wherein the data are interchanged via a first interface, and the initiation is effected via a second interface.

12. The method of claim 8, wherein the standard interface corresponds to the ISO-7816 standard.

13. A communications system comprising a chip card and a chip card communications partner, wherein the chip card has a means for initiating data interchange with the chip card communications partner.
